(19) United States
(12) Patent Application Publication
(10) Pub. No.: US 2008/0069071 A1
(43) Pub. Date: Mar. 20, 2008

(54) DYNAMIC SELECTION OF WIRELESS INFORMATION COMMUNICATION MODES FOR A WIRELESS COMMUNICATION DEVICE

(75) Inventor: Dah-Lain Almon Tang, Naperville, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/532,202

(22) Filed: Sep. 15, 2006

(51) Int. Cl. H04B 7/216

(52) U.S. Cl. 370/342

(57) ABSTRACT

A wireless communication system, and method therefore, dynamically selects a wireless communication mode for wirelessly communicating information to at least one wireless communication device (104). The method includes receiving at least one request for wireless communication of information to at least one wireless communication device (104). A total number of time-slots required for transmitting the wireless communication of information to the least one wireless communication device (104) is determined for each of a set of wireless communication modes. The total number of time-slots required for each wireless communication mode is compared to every other wireless communication mode of the set. A wireless communication mode is selected, based at least in part on the comparison of the total number of required time-slots, from the set of wireless communication modes for wirelessly communicating the requested information to the at least one wireless communication device (104).

### FIELD OF THE INVENTION

The present invention generally relates to the field of wireless communication devices, and more particularly relates to dynamically managing broadcast/multicast and unicast communication modes for wireless communication devices.

### BACKGROUND OF THE INVENTION

Wireless communication devices have evolved greatly over the past few years. A wide variety of content such as stock quotes, news, weather, video/audio, and the like can now be provided to a wireless communication device. To provide such diverse content in an efficient manner, two types of wireless information communication modes can be used. The first wireless information communication mode is unicast. Unicast communication sends a copy of the requested information to each of the requesting devices. Unicast is a point-to-point communication method and is useful when not transmitting to large numbers of receiving devices.

The second wireless information communication mode is broadcast/multicast services or BCMCS. The Third Generation Partnership Project 2 or 3GPP2 standards define BCMCS as a service intended to provide a flexible and efficient mechanism to send common (the same) information to multiple users using the most efficient use of air interface and network resources. Retransmission and acknowledgment in BCMCS are not required, since the type of transmission is “one way” and “one to many”. Users (wireless communication devices) can subscribe to BCMCS. For example, a BCMCS subscription is normally associated with the program (e.g. CNN, Disney Channel, Sports Channel). In another embodiment, a BCMCS subscription is also associated with media related services such as pay-per-view. By selecting the program, the user selects the type of content he or she wishes to receive. However, the type of information transmitted could be any type of data, e.g. text, multimedia (e.g. voice), real-time, and non-real-time streaming media.

BCMCS programs may be transmitted to all or selected regions of a wireless communications network. These regions constitute the transmission territory. Operationally, the transmission territory for each BCMCS program can be independently defined.

Although unicast and broadcasting/multicasting modes are useful methods for transmitting information, an efficient way to optimize these unicast and broadcast/multicast communication modes in a wireless communications system does not exist. Current standards do not define how broadcast/multicast services should be delivered to wireless communication devices.

Therefore a need exists to overcome the problems with the prior art as discussed above.

### SUMMARY OF THE INVENTION

Briefly, in accordance with the present invention, disclosed is a system, and method, for dynamically selecting a wireless communication mode for wirelessly communicating information to at least one wireless communication device. The method comprises receiving at least one request for wireless communication of information to at least one wireless communication device. A total number of time-slots required for transmitting the wireless communication of information to the at least one wireless communication device is determined for each of a set of wireless communication modes. The total number of time-slots required for each wireless communication mode is compared to every other wireless communication mode of the set. A wireless communication mode is selected, based at least in part on the comparison of the total number of required time-slots, from the set of wireless communication modes for wirelessly communicating the requested information to the at least one wireless communication device.

In another embodiment of the present invention, a wireless communication system for dynamically selecting a wireless communication mode for wirelessly communicating information to at least one wireless communication device is provided. The system comprises at least a base station controller. The base station controller includes a receiver for receiving at least one request for wireless communication of information from at least one wireless communication device. The base station controller also includes a time-slot counter for determining a total number of time-slots required for a set of wireless communication modes available for transmitting the requested information. A time-slot number comparator is also included for comparing the total number of time-slots required for each wireless communication mode to every other wireless communication mode of the set. The base station controller also includes a wireless communication mode selector for selecting a wireless communication mode from the set of wireless communication modes for wirelessly communicating the requested information to the at least one wireless communication device. The wireless communication mode is selected based at least in part on the comparison of the total number of required time-slots.

An advantage of the foregoing embodiments of the present invention is that wireless information communication modes such as unicast and broadcast/multicast are dynamically selected to optimize the wireless transmission of information to a wireless communication device. A further advantage is that a base-station controller controls the switching between wireless communication modes. The wireless communication mode, according to an embodiment, is based on the number of time-slots needed to transmit requested data. Another advantage, according to another embodiment, is that the base station controller prepares wireless communication devices for a communication mode prior to a hand-off event (prior to a wireless communication device crossing over into a new target area) thereby minimizing transmission gaps when crossing seams.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating an exemplary wireless communications system, according to an embodiment of the present invention;

FIG. 2 is a block diagram illustrating an exemplary wireless communication device, according to an embodiment of the present invention;

FIG. 3 is a block diagram illustrating an exemplary information processing system, according to an embodiment of the present invention;

FIG. 4 is a system block diagram illustrating the dynamic managing of wireless information communications modes, according to an embodiment of the present invention;

FIG. 5 is a timing and logic diagram illustrating logical flows for using an information broadcasting wireless communication mode and a wireless unicast communication mode, according to an embodiment of the present invention;

FIG. 6 is an operational flow diagram illustrating an exemplary process of dynamically selecting a wireless information communication mode based on time-slot information, according to an embodiment of the present invention;

FIG. 7 is an operational flow diagram illustrating another exemplary process of dynamically selecting a wireless information communication mode, according to an embodiment of the present invention;

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The presently claimed invention, according to an embodiment, overcomes problems with the prior art by optimizing the wireless communication of information to wireless communication devices. An embodiment of the present invention dynamically selects a wireless information communication mode based at least in part on the total number of wireless communication devices to receive particular information and the bandwidth used by these devices.

The term wireless communication device is intended to broadly cover many different types of devices that can wirelessly receive signals, and optionally can wirelessly transmit signals, and may also operate in a wireless communication system. For example, and not for any limitation, a wireless communication device can include any one or a combination of the following: a cellular telephone, a mobile phone, a smartphone, a two-way radio, a two-way pager, a wireless messaging device, a laptop/computer, automotive gateway, residential gateway, and the like.

Exemplary Wireless Communication System

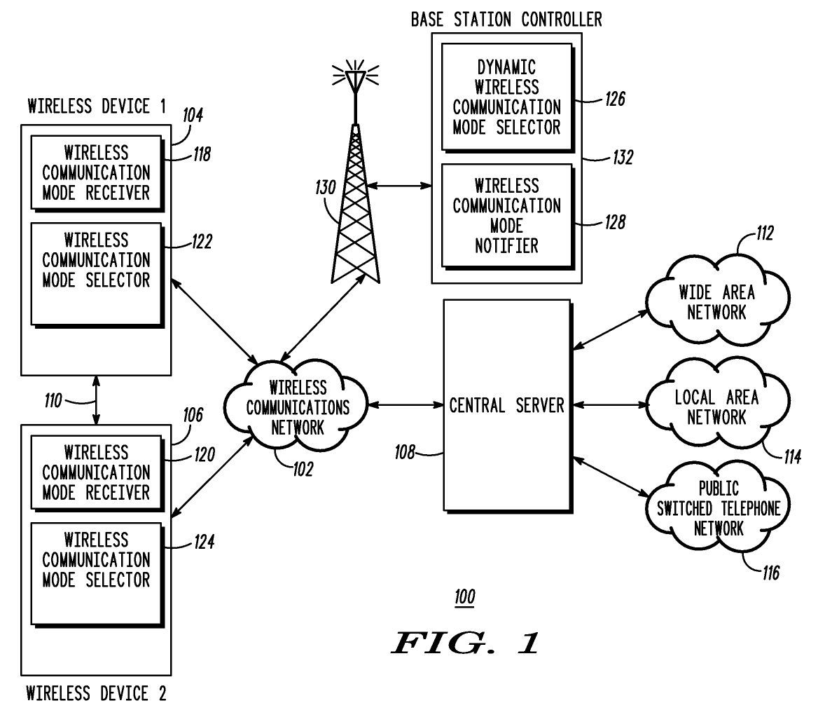

According to an embodiment of the present invention, as shown in FIG. 1, an exemplary wireless communications system 100 is illustrated. FIG. 1 shows a wireless communications network 102, that connects wireless communication devices such as wireless communication device1 104 and wireless communication device2 106 with a central server 108. The wireless communications network 102 comprises a mobile phone network, a mobile text messaging device network, a pager network, or the like. Further, the communications standard of the wireless communications network 102 of FIG. 1 comprises Code Division Multiple Access (CDMA), Time Division Multiple Access (TDMA), Global System for Mobile Communications (GSM), General Packet Radio Service (GPRS), Frequency Division Multiple Access (FDMA), Orthogonal Frequency Division Multiplexing (OFDM), or the like.

Additionally, the wireless communications network 102 also comprises text messaging standards, for example, Short Message Service (SMS), Enhanced Messaging Service (EMS), Multimedia Messaging Service (MMS), or the like. The wireless communications network 102 also allows for push-to-talk over cellular communications between capable wireless communication devices. In one embodiment the wireless communications network 102 is a meshed network.

The wireless network 102 supports any number of wireless communication devices 104, 106. The support of the wireless network 102 includes support for mobile telephones, smart phones, text messaging devices, handheld computers, pagers, beepers, or the like. A smart phone is a combination of 1) a pocket PC, handheld PC, palm top PC, or Personal Digital Assistant (PDA), and 2) a mobile telephone. More generally, a smartphone can be a mobile telephone that has additional application processing capabilities. In one embodiment, the wireless communications network 102 includes one or more base stations (not shown).

Additionally, in one embodiment, the wireless communication devices 104, 106 also include an optional local wireless link 110 that allows the wireless communication devices 104, 106 to directly communicate with each other or with other devices without using the wireless network 102. The optional local wireless link 110, for example, is provided by Bluetooth, Infrared Data Access (IrDA) technologies or the like.

The wireless communication devices 104, 106 include a wireless communication mode receiver 118, 120 and a wireless communication mode selector 122, 124. In one embodiment, the wireless communication mode receiver 118, 120 receives wireless communication mode information from a base station 130. For example, the base station 130 transmits a wireless communication mode message to wireless communication devices 104, 106. The message notifies the wireless communication devices 104, 106 to use a specific wireless mode such as an information broadcast mode, a multicast mode, and a unicast mode. The wireless communication mode selector 122, 124 dynamically selects the appropriate wireless communication mode according to the information provided via the base station 130. In one embodiment, the wireless communication devices 104, 106 are capable of receiving broadcast/multicast services.

In one embodiment, the wireless communication devices 104,106 send a request for broadcast/multicast (“BCMCS”) information to a source providing that information. The wireless communication devices 104,106 then receive instructions from the base station controller 132 regarding the mode that the BCMCS content is to be transmitted by the base station 130. During reception of the BCMCS content using a particular communication mode, the base station controller 132 can instruct the wireless communication devices 104, 106 to switch communication modes. In other words, the mode used to transmit the BCMCS can be changed during the transmission. The wireless communication devices 104, 106, in one embodiment, can further request to continue to receive the BCMCS content when moving to a different transmission area such as a cell within a cellular network. The base station controller 132 communicates to the wireless communication devices 104, 106 the transmission mode that the next base station is using to transmit the BCMCS content.

The base station 130 is communicatively coupled to a base station controller 132 (“BSC”). The base station controller 132 includes a dynamic wireless communication mode selector 126 and a wireless communication mode notifier 128. The dynamic wireless communication mode selector 126 dynamically selects a wireless communication mode for wirelessly communicating with the wireless devices 104, 106. For example, based on the number of time-slots needed to transmit requested data, the dynamic wireless communication mode selector 126 dynamically selects a wireless communication mode such as an information broadcasting mode, a multicast mode, or a unicast mode. The unicast mode, in one embodiment, transmits BCMCS traffic by unicast or point-to-point traffic by unicast. The wireless communication mode notifier 128 notifies the wireless devices 104, 106 to use a specific wireless communication mode. The dynamic wireless communication mode selector 126 and the wireless communication mode notifier 128 are discussed in greater detail below.

The central server 108 maintains and processes information for all wireless devices such as the wireless communication devices 104, 106 communicating on the wireless network 102. Additionally, the central server 108, in this example, communicatively couples the wireless communications devices 104, 106 to a wide area network 112, a local area network 114, and a public switched telephone network 116 through the wireless communications network 102. Each of these networks 112, 114, 116 has the capability of sending data, for example, a multimedia text message to the wireless devices 104, 106.

Exemplary Wireless Communication Device

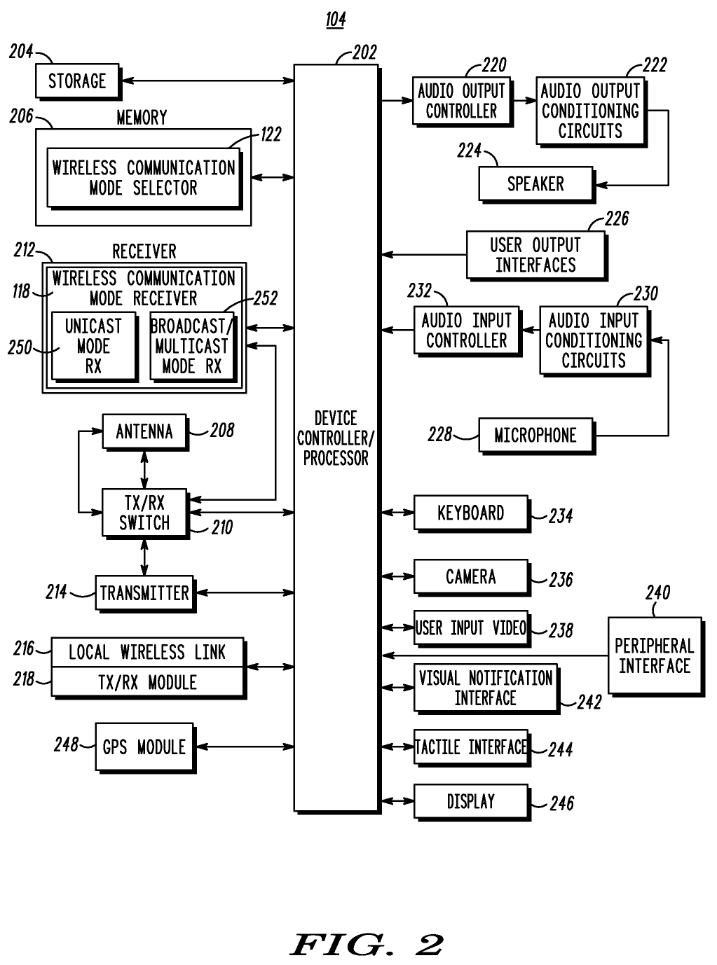

FIG. 2 is a block diagram illustrating a more detailed view of the wireless communication device 104. The wireless communication device 104 operates under the control of a device controller/processor 202, that controls the sending and receiving of wireless communication signals. In receive mode, the device controller 202 electrically couples an antenna 208 through a transmit/receive switch 210 to a receiver 212. The receiver 212 decodes the received signals and provides those decoded signals to the device controller 202. The receiver 212 also includes the wireless communication mode receiver 118. The wireless communication mode receiver 118, in one embodiment, further includes a unicast communication mode receiver 250 and an information broadcasting/multicast mode receiver 252.

The unicast communication mode receiver 250 receives a notification from the base station controller 132 via the base station 130 to use a unicast communication for wirelessly receiving requested information. As discussed above, the wireless communication device 104, 106 can receive point-to-point traffic by unicast or BCMCS traffic by unicast. The unicast mode receiver 250 and the broadcast/multicast mode receiver 252 are for processing BCMCS content received by unicast and by broadcast, respectively. The information broadcasting/multicast mode receiver 252 receives a notification from the base station controller 132 via the base station 130 to use an information broadcasting communication mode or multicast mode for wirelessly receiving requested information.

In transmit mode, the device controller 202 electrically couples the antenna 208, through the transmit/receive switch 210, to a transmitter 214. The device controller 202 operates the transmitter and receiver according to instructions stored in the memory 206. These instructions include, for example, a neighbor cell measurement-scheduling algorithm. The memory 206 also includes the wireless communication mode selector 122. The wireless communication mode selector 122 selects, for example, a unicast mode or broadcast mode for receiving BCMCS content based on instructions received from the base station controller 132. Although shown residing in memory, the wireless communication mode selector 122, in one embodiment, is implemented as a hardware component. In another embodiment, the transmitter 214 transmits data rate control (“DRC”) information to the base station controller 130.

FIG. 2 also includes non-volatile storage memory 204 for storing, for example, an application waiting to be executed (not shown) on the wireless communication device 104. The wireless communication device 104, in this example, also includes an optional local wireless link 216 that allows the wireless communication device 104 to directly communicate with another wireless device without using a wireless network (not shown). The optional local wireless link 216, for example, is provided by Bluetooth, Infrared Data Access (IrDA) technologies, or the like. The optional local wireless link 216 also includes a local wireless link transmit/receive module 218 that allows the wireless device 104 to directly communicate with another wireless communication device.

The wireless communication device 104 of FIG. 2 further includes an audio output controller 220 that receives decoded audio output signals from the receiver 212 or the local wireless link transmit/receive module 218. The audio controller 220 sends the received decoded audio signals to the audio output conditioning circuits 222 that perform various conditioning functions. For example, the audio output conditioning circuits 222 may reduce noise or amplify the signal. A speaker 224 receives the conditioned audio signals and allows audio output for listening by a user. The audio output controller 220, audio output conditioning circuits 222, and the speaker 224 also allow for an audible alert to be generated notifying the user of a missed call, received messages, or the like. The wireless communication device 104 further includes additional user output interfaces 226, for example, a head phone jack (not shown) or a hands-free speaker (not shown).

The wireless communication device 104 also includes a microphone 228 for allowing a user to input audio signals into the wireless communication device 104. Sound waves are received by the microphone 228 and are converted into an electrical audio signal. Audio input conditioning circuits 230 receive the audio signal and perform various conditioning functions on the audio signal, for example, noise reduction. An audio input controller 232 receives the conditioned audio signal and sends a representation of the audio signal to the device controller 202.

The wireless communication device 104 also comprises a keyboard 234 for allowing a user to enter information into the wireless communication device 104. The wireless communication device 104 further comprises a camera 236 for allowing a user to capture still images or video images into memory 204. Furthermore, the wireless communication device 104 includes additional user input interfaces 238, for example, touch screen technology (not shown), a joystick (not shown), or a scroll wheel (not shown). In one embodiment, a peripheral interface 240 is included for allowing the connection of a data cable to the wireless communication device 104. In one embodiment of the present invention, the connection of a data cable allows the wireless communication device 104 to be connected to a computer or a printer.

A visual notification (or indication) interface 242 is also included on the wireless communication device 104 for rendering a visual notification (or visual indication), for example, a sequence of colored lights on the display 246 or flashing one ore more LEDs (not shown), to the user of the wireless communication device 104. For example, a received multimedia message may include a sequence of colored lights to be displayed to the user as part of the message. Alternatively, the visual notification interface 242 can be used as an alert by displaying a sequence of colored lights or a single flashing light on the display 246 or LEDs (not shown) when the wireless communication device 104 receives a message, or the user missed a call.

The wireless communication device 104 also includes a tactile interface 244 for delivering a vibrating media component, tactile alert, or the like. For example, a multimedia message received by the wireless communication device 104, may include a video media component that provides a vibration during playback of the multimedia message. The tactile interface 244, in one embodiment, is used during a silent mode of the wireless communication device 104 to alert the user of an incoming call or message, missed call, or the like. The tactile interface 244 allows this vibration to occur, for example, through a vibrating motor or the like.

The wireless communication device 104 also includes a display 246 for displaying information to the user of the wireless communication device 104 and an optional Global Positioning System (GPS) module 248. The optional GPS module 248 determines the location and/or velocity information of the wireless communication device 104. This module 248 uses the GPS satellite system to determine the location and/or velocity of the wireless communication device 104. Alternative to the GPS module 248, the wireless communication device 104 may include alternative modules for determining the location and/or velocity of wireless communication device 104, for example, using cell tower triangulation and assisted GPS.

Exemplary Information Processing System

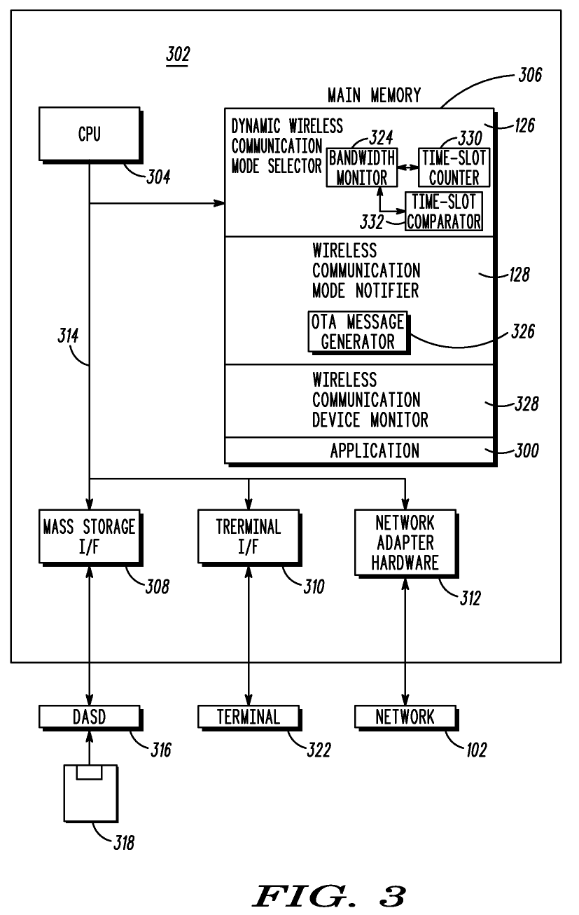

FIG. 3 is a block diagram illustrating a more detailed view of the base station controller 132 according to an embodiment of the present invention. The base station controller 132 is based upon a suitably configured processing system adapted to implement the exemplary embodiment of the present invention. Any suitably configured processing system is similarly able to be used as the base station controller 132 by embodiments of the present invention. For example, a personal computer, workstation, or the like, may be used. The base station controller 132 includes a computer 302. The computer 302 has a processor 304 that is connected to a main memory 306, mass storage interface 308, terminal interface 310, and network adapter hardware 312. A system bus 314 interconnects these system components. Mass storage interface 308 is used to connect mass storage devices, such as data storage device 316, to the base station controller 132. One specific type of data storage device is a computer readable medium such as a floppy disk drive, which may be used to store data to and read data from a floppy diskette 318 or CD/DVD (not shown). Another type of data storage device is a data storage device configured to support New Technology File System (“NTFS”) operations.

The main memory includes the dynamic wireless communication mode selector 126. The dynamic wireless communication mode selector 126 dynamically selects a wireless communication mode for transmitting data to requesting wireless communication devices 104, 106. In one embodiment, the dynamic wireless communication mode selector 126 switches between a broadcast, multicast, or unicast mode based on the number of time-slots required for transmission of requested data. In one embodiment, the dynamic wireless communication mode selector 126 or other designated component sets up unicast traffic channels for BCMCS content when a unicast communication mode is selected. Broadcast services are services involving the simultaneous transmission of the same data to multiple destinations in near real-time. Generally, the content is broadcast to wide, local, regional, or national areas, reaching a large number of widely distributed users. The service may be free or may require subscription. Television and AM/FM radio are a few examples of broadcast services.

Multicast Services are services involving the transmission of data destined for more than one destination wireless device as compared to a unicast service where a transmission, and a copy of the data, is sent to each individual destination. The multicast transmission mode is a limited form of broadcast where the content is distributed to a much more limited number of users. One example of a multicast service comprises location based advertisements. Another example of multicast is when an information channel is only available to a select group of users who have subscribed to the channel.

The dynamic wireless communication mode selector 126 includes a bandwidth monitor 324 such as a receiver that monitors the incoming requests for data and calculates the number of time slots via a time slot counter 330 that are needed for transmitting the requested data. For example, a group of wireless communication devices 104, 106 in a single sector or multiple sectors request transmission of the same data such as a program, video, audio, or the like. In one embodiment, the number of required time-slots for both broadcast/multicast and unicast modes are calculated together. In another embodiment, the communication mode that requires the least amount of bandwidth (time-slots) is selected as the communication mode.

The bandwidth (time-slot) monitor 324, in another embodiment, via a time slot comparator 332 determines if the number of time-slots required for transmission of the requested data by unicast is above or below a predefined threshold, or an on-line computed threshold. If the threshold is exceeded the dynamic wireless communication mode selector 126 selects broadcast/multicast as the communication mode. If the threshold is not exceeded, the dynamic wireless communication mode selector 126 selects the unicast transmission mode.

In one embodiment, new wireless devices subscribe (register) to a broadcast/multicast already occurring. Similarly, devices can de-register (un-subscribe), move into another sector, or get switched over to another carrier during the broadcast/multicast of information. In this embodiment, the bandwidth monitor 324 updates the number of timeslots required for the transmission of the requested data. The bandwidth monitor 324 determines if the number of time-slots for transmission by unicast is above or below a second predefined threshold or on-line computed threshold. If the required number of time-slots is above the second threshold, the dynamic wireless communication mode selector 126 continues to transmit the requested data using broadcast/multicast. If the required number of timeslots is below the second threshold, the dynamic wireless communication mode selector 126 switches to the unicast mode. In one embodiment, the second threshold is set lower than the first threshold. This provides a hysteresis region between the two thresholds, which reduces the amount of thrashing between the two modes that a wireless device may experience. In one embodiment, a timer is included in the processing to prevent the transmission mode to switch from broadcast to unicast too frequently.

When calculating the number of time-slots for broadcast/multicast, the dynamic wireless communication mode selector 126 calculates out to the edge of its cell(s). Generally, the transmission rate for broadcast/multicast transmission is slower overall (slowed down) than unicast to individual wireless devices. This slower transmission is caused due to multiple-time slots and a conservative coding scheme being used to maintain an acceptable error rate for reception of a transmission at a wireless device located farthest from the transmitter. One example of when the number of time-slots for broadcast/multicast can be greater than for unicast is when there is a group of subscribing devices situated near the center of a cell. In another example, broadcast coverage is based on the location of a device furthest from the base station 130. Because broadcast/multicast bandwidth is calculated out to the edge of a cell and in this example there is one device near the edge with other devices near the center, more time-slots can be required for broadcast/multicast for all devices in the multicast group due to the selection of a conservative coding scheme. Additional examples include when the broadcast/multicast area is composed of the coverage area of more than a sector of the BTS 130 or a group of them.

The main memory 306 also includes a wireless communication mode notifier 128. Once a communication mode is selected the wireless communication mode notifier 128 notifies requesting devices and/or already subscribed devices of the wireless communication mode to use. The wireless communication mode notifier 128 includes an over-the-air message (“OTA”) generator 326. Once the base station controller 132 determines that broadcast/multicast mode should be used, it adds broadcast channel information (“BCI”) in the OTA for all the requesting and/or subscribing devices. Wireless communication devices 104, 106 that join the broadcast/multicast at a later time detect the program availability and start time through the BCI. In one embodiment, the subscribing wireless devices 104, 106 monitor the OTA and detect and record the BCI in the OTA. The wireless devices 104, 106 then prepare to receive the program by broadcast/multicast. After a pre-configured time interval, which is embedded within the OTA, the wireless devices 104, 106 begin to monitor the broadcast channel. The pre-configured time interval indicates when the broadcast starts.

If unicast is selected as the communication mode, the OTA message generator 326 does not place the BCI in the OTA. The dynamic wireless communication mode selector 126 establishes dedicated channels with the subscribing wireless devices 104, 106 before the broadcast/multicast program starts. Subscribing wireless devices 104, 106 that join later are notified to use unicast communication. If the wireless communication mode is being switched from broadcast/multicast to unicast, the dynamic wireless communication mode selector 126 terminates the broadcast and removes the BCI from the OTA after all subscribing wireless devices 104, 106 have been switched to unicast. The notification that the broadcast flow is now unicast allows the wireless devices 104, 106 to differentiate between a broadcast flow that is unicast and a conventional point-to-point unicast flow that may use different processing or protocols, e.g. Radio Link Protocol.

The main memory 306 also includes a wireless communication device monitor 328. The wireless communication device monitor monitors the wireless devices 104, 106 within the cells controlled by the base station controller 132. For example, the wireless communication device monitor 328 can determine when a wireless device 104, 106 is crossing over to a new sector or to a new carrier. The base station controller 132, in one embodiment, prepares the wireless device 104, 106 for a communication mode currently being used at the new target location prior to the wireless device 104, 106 completely crossing over into the target location.

For example, if the wireless device 104, 106 is currently receiving requested data using a unicast mode and the new target location is using a broadcast communication mode for the data, the wireless communication mode notifier 128 notifies and prepares the wireless device 104, 106 for the broadcast mode. It should be noted that when a wireless device 104, 106 is crossing over into a new target and is in the overlapping area between the target area and the current area, the base station controller of either area can notify the wireless device 104, 106 of the communication mode to use.

The memory 306 also includes an application 320 that is running or waiting to be executed. Although illustrated as concurrently resident in the main memory 306, it is clear that respective components of the main memory 306 are not required to be completely resident in the main memory 306 at all times or even at the same time. In one embodiment, the base station controller 132 utilizes conventional virtual addressing mechanisms to allow programs to behave as if they have access to a large, single storage entity, referred to herein as a computer system memory, instead of access to multiple, smaller storage entities such as the main memory 306 and data storage device 316. Note that the term “computer system memory” is used herein to generically refer to the entire virtual memory of the BSC 132.

Although only one CPU 304 is illustrated for computer 302, computer systems with multiple CPUs can be used equally effectively. Embodiments of the present invention further incorporate interfaces that each includes separate, fully programmed microprocessors that are used to off-load processing from the CPU 304. Terminal interface 310 is used to directly connect one or more terminals 322 to computer 302 to provide a user interface to the base station controller 132. These terminals 322, which are able to be non-intelligent or fully programmable workstations, are used to allow system administrators and users to communicate with the base station controller 132. The terminal 322 is also able to consist of user interface and peripheral devices that are connected to computer 302 and controlled by terminal interface hardware included in the terminal I/F 310 that includes video adapters and interfaces for keyboards, pointing devices, and the like.

An operating system (not shown) included in the main memory is a suitable multitasking operating system such as the Linux, UNIX, Windows XP, and Windows Server 2003 operating system. Embodiments of the present invention are able to use any other suitable operating system. Some embodiments of the present invention utilize architectures, such as an object oriented framework mechanism, that allows instructions of the components of operating system (not shown) to be executed on any processor located within the base station controller 132.

The network adapter hardware 312 is used to provide an interface to the network 102. Embodiments of the present invention are able to be adapted to work with any data communications connections including present day analog and/or digital techniques or via a future networking mechanism.

Although the exemplary embodiments of the present invention are described in the context of a fully functional computer system, those skilled in the art will appreciate that embodiments are capable of being distributed as a program product via floppy disk, e.g. floppy disk 318, CD ROM, or other form of recordable media, or via any type of electronic transmission mechanism.

Exemplary Wireless Communication System Block Diagram

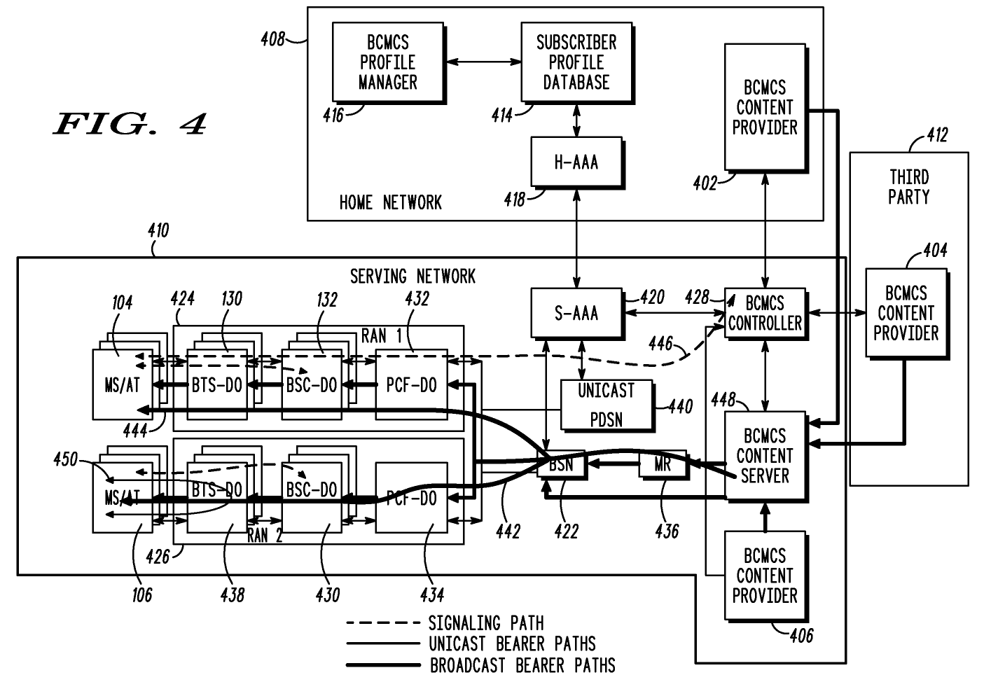

FIG. 4 is a block diagram illustrating an exemplary system communication flow for dynamically switching between wireless communication modes according to an embodiment of the present invention. The system communication flow of FIG. 4 is directed towards a 3GPP2 network and is only one example of how the present invention can be implemented. The present invention is not limited to a 3GPP2 network as the present invention is applicable to other wireless networks as well, as should be obvious to those of ordinary skill in the art in view of the present discussion.

FIG. 4 shows a BCMCS content provider 402, 404, 406 which creates or comprises the content that is to be provided to the wireless communication devices 104, 106. For example, the BCMCS content provider 402, 404, 406 can reside in the home network 408 or serving network 410 of the wireless communication devices 104, 106. The BCMCS content provider can also reside at a third party location 412. A subscriber profile database 414 is also included in the home network 408. The subscriber profile database 414 is responsible for storing a BCMCS subscription profile (not shown). The BCMCS subscription profile (not shown) identifies the BCMCS sessions that a wireless communication device 104, 106 can receive.

The home network 408, in one embodiment also includes a BCMCS subscriber profile manager 416 and home-AAA 418. The BCMCS subscriber profile manager 416, for example, is an application that updates the BCMCS subscription profile (not shown) in the subscriber profile database 414 regarding the subscribed to broadcast/multicast programs. A wireless communication device 104, 106 can interface to the BCMCS profile manager 416 directly, or an administrator of the BCMCS profile manager 416 may reserve access to the BCMCS profile manager 416 to customer service agents only. The home and serving network authentication, authorization and accounting (“H-AAA”) and (“S-AAA”) servers 418, 420 are responsible for service authentication, authorization, and accounting. The H-AAA 418 accesses the subscriber profile database 414 to obtain information from the subscription profile (not shown). In one embodiment, the S-AAA 420 and BCMCS controller 428 query the H-AAA 418 for the subscription profile (not shown).

The serving network 410 includes the networks 424, 426, BCMCS Content provider 406 and central server 108 (FIG. 1). In one embodiment, the central server consists of both a BCMCS controller 428 and BCMCS Content Server 448. In another embodiment, the BCMCS controller 428 and BCMCS Content Server 448 are separated entities. The BCMCS controller 428 is a core network function that is responsible for managing and providing BCMCS session information. This information is provided to a broadcast serving node 422 (“BSN”), and the radio access network 424, 426 (“RAN”) for the establishment of sessions and bearer paths, optionally via the S-AAA 420. The RAN 424, 426, which includes the base station controller 132, 430, also dynamically switches the wireless communication devices 104, 106 between broadcast, multicast, and unicast communication modes via the base station controller 132, as described above with respect to FIG. 3.

In one embodiment, the BCMCS controller 428 is communicatively coupled with the wireless communication devices 104, 106 via a packet data serving node (“PDSN”) such as the unicast PDSN 440, to enable the wireless communication devices to obtain program information, register and deregister for service/programs. The BCMCS controller 428 is communicatively coupled with the BCMCS content server 448 to direct the content server on establishment and termination of bearer paths. The BCMCS controller 428 optionally performs authorization using the BCMCS subscriber profile (not shown) residing in the subscriber profile database 414 through the H-AAA 418. In one embodiment, the BCMCS controller 428 distributes broadcast access keys (“BAK”) and may optionally generate them as well. The BCMCS controller 428, in one embodiment, also performs discovery operations to assist the wireless communication devices 104, 106 to find desired content such as stock information, weather information, and the like. The BCMCS controller 428, in one embodiment, also authenticates the BCMCS content provider 402, 404, 406, and coordinates the delivery of BCMCS content to the BCMCS content server 448.

The RAN 424, 426, in one embodiment, via the base station controller 132, maintains a wireless communication device count per flow/sector and a time-slot count for each request of information. For example, a count is maintained for the number of wireless communication devices currently receiving the same wireless information. A flow is a stream of information, such as a CNN video broadcast. The time-slot count is used by the RAN 424, 426, for example, to determine when to dynamically switch a wireless communication mode from unicast to broadcast/multicast or from broadcast/multicast to unicast based at least in part on predefined thresholds.

The BCMCS content server 448 formats the BCMCS content to allow content requested by a wireless communication device 104, 106 to be provided within an IP Multicast stream. The BCMCS content server 448, in one embodiment, includes control logic (not shown) to interface with the BCMCS controller 428 and BCMCS content providers 402, 404, 406 (FIG. 4) and buffers for data payload. In another embodiment, the BCMCS content server 448 also includes media converters/format converters for converting media/format to what is acceptable by the wireless devices 104, 106. The BCMCS content server 448 residing in the serving network 410 is not necessarily the creator or source of the content; it is the last application level entity to manipulate (e.g., reformat) the content prior to the content reaching the broadcast serving node 422 (“BSN”). The BCMCS content server 448, in one embodiment, stores and forwards the content from the BCMCS content provider 402, 404, 406 and merges the content from the multiple content providers 402, 404, 406. In one embodiment, if higher layer encryption is enabled, the BCMCS content server 448 can encrypt the stream content. In this case, the BCMCS content server 448 may also generate short term keys and BAKs.

The unicast PDSN 440 communicates with the base station controller 132, 430 (“BSC”) and the packet control function 432, 434 (“PCF”) to add and remove unicast IP flows. The unicast PDSN 440 supports normal point-to-point protocol (“PPP”) connections to and from the wireless communication devices 104, 106. The unicast PDSN 440 acts as the first-hop router for IP unicast traffic to and from the wireless communication devices 104, 106. In one embodiment, the BCMCS content is only transmitted via the broadcast bearer path between the BSC 132, 430 and the BCMCS server 448 regardless if the content is to be transmitted using a unicast or broadcast mode over the air. The unicast path for a broadcast mode, in one embodiment, is used between the BSC 132, 430 and the wireless communication devices 104, 106 when a BCMCS program is to be transmitted over the air using unicast channels.

When the BCMCS program is unicast, an identification may be required at the wireless communication devices 104, 106 to differentiate the BCMCS data from regular point-to-point data so BCMCS specific processing can be applied. The point-to-point unicast path, in one embodiment, is implemented as defined by 3GPP2 for wireless communication devices 104, 106 to obtain from the BCMCS controller 428 the BCMCS program information such as program title, schedule, subscription and receiving the BAK for subscribed program.

Around the starting time of the subscribed BCMCS program, the wireless communication device 104, 106, in one embodiment, begins to send a request to receive the BCMCS content by sending a BCMCS registration message to the BSC 132, 430. The BSC 132, 430 then forwards the BCMCS registration message to the BSN 422, and the BSN 422 then forwards it to the BCMCS controller 428. After the request is authenticated and authorized, the BCMCS controller 428 then sets up the BCMCS bearer path 442, 444 all the way to the BSC 132, 430 or BTS 130, 438. If the broadcast/unicast switch is placed at the BSC 132, 430 (such as cdma2000 1× and for this system, the decision, in one embodiment is not based on time slots, but overall transmission power), the BSC 132, 430 may terminate the broadcast bearer path 444, 442 and switch it to unicast bearer path 450 to transmit the BCMCS program.

If the broadcast/unicast switch is placed at the BTS 130, 438 (such as cdma2000 HRPD), the BSC 132, 430 may notify the specific BTS 130, 438 to terminate the broadcast bearer path 444, 442 and switch it to unicast radio channels to transmit the BCMCS program. In both cases, the decision is made by the BSC 132, 430. The BSC 132, 430, in one embodiment, provides an identifier in the data packets to the BTS 130, 438 so the BTS 130, 438 can tell if the type of data to be received is point-to-point data, BCMCS data using unicast, or BCMCS data using broadcast. This identifier can be either by a specific port number used as configured or an additional field in the outer header of the data packets. The BSC 132, 430 may add the BCMCS channel information on the BCMCS overhead channel and notify the wireless communication devices 104, 106 if the BCMCS program is to be broadcast or unicast.

In one embodiment, the BSN 422 communicates with the PCF 432, 434 to add and remove multicast and broadcast IP flows. The BSN 422, in one embodiment, uses IP multicast protocols to manage bearer paths 442, 444. A bearer path 442, 444, for example, is a virtual connection which is used to transport the information to the wireless device 104, 106. The term “bearer” refers to the information (such as CNN) that supports multicast IP flows between the BSN 422 and the nearest router connecting back to the BCMCS content server 448. The BSN 422, in one embodiment, applies the flow treatment received from the BCMCS controller 428 to the multicast IP flows.

A multicast router 436 (“MR”) is also included in the serving network 410. In an alternative embodiment where the BCMCS content server 448 connects directly to the BSN 422 via Generic Routing Encapsulation (“GRE”) tunnels, the MR 436 is not included in the serving network 410. The data optimized base station controller 132, 430 (“BSC-DO”) and the data optimized packet control function PCF 432, 434 (“PCF-DO”) are responsible for signaling, establishing, and tearing down bearer paths between the BSN 422 and the wireless devices 104, 106. The BSC-DO 132, 430 selects the best bearer path to the wireless device 104, 106 based on considerations such as optimization of resources, quality of service (“QoS”) requested, and the like. The BSC-DO 132, 430 also establishes BCMCS transmission territories and supports segment based framing.

The PCF-DO 432, 434 is included in the RAN 424, 426. The PCF-DO 432, 434 connects to multiple PDSNs and BSNs allowing it to receive BCMCS programs for any BSN capable of transmitting a BCMCS program. A base transceiver station (data optimized) 130, 438 (“BTS-DO”) is also included in the RAN 424, 426. The BTS-DO 130, 438 provides the radio interface to the wireless devices 104, 106. BTSs are “homed” on a BSC-DO 132, 430. In one embodiment, the BTS 130 includes a broadcast/unicast switch for dynamically switching communication modes via the base station controller 132. In another embodiment, the broadcast/unicast switch is placed at the BSC when the Broadcast bearer path is switched at the BSC-DO 132, 430.

FIG. 4 also shows a unicast communication path 450, a broadcast/multicast communication path 444, and a signaling path 446. The broadcast/multicast communication path 444 travels from the BCMCS content server 448 through the optional multicast router 436 and the BSN 422 to the wireless communication device 104. The BSN 422 generates an IP multicast flow for the requested broadcast/multicast information. The BSN 422 for broadcast/multicast flows is equivalent to the unicast PDSN 440 for unicast flows. As can be seen, only one bearer path is generated from the BCMCS content server 448 all the way to the base station (BST-DO) 130. This single bearer path supports all of the subscribers in the sector(s) of the base station 130. In one embodiment, the signaling paths for multicast, broadcast, and unicast as well as the bearer paths for these modes are mostly shared. The RAN 424, 426 is then able to notify the subscribing devices of when to switch communication modes over this single bearer path 444. This is advantageous because network resources such as bandwidth are not wasted by having multiple bearer paths.

The unicast communication path 450 travels from the BTS-DO 438 to the wireless communication device 106. The BSC-DO 430 includes a broadcast/unicast switch that generates the communication path 450. The unicast communication path 450 represents a unicast channel on which information is being wirelessly communicated to the wireless device 106 using a unicast communication mode. In one embodiment, a wireless communication unicast communication mode is used, for example, when a threshold has not been reached, e.g. not enough time-slots required. Unicast communication is also used when broadcast/multicast resources are not available. Multiple unicast channels can be established to transmit information to the wireless communication devices 104, 106. As can be seen, the unicast path 450 travels from the BSC-DO 132 to the wireless device 106. The path does not start farther back within the network such as from the BCMCS content server 448. This is because the base station controller 132 controls the switching of communication modes. This allows for a faster switching between communication modes and more efficient setup of the wireless devices 104, 106.

Logical Flow Diagram for Unicast Broadcast Multicast Communications

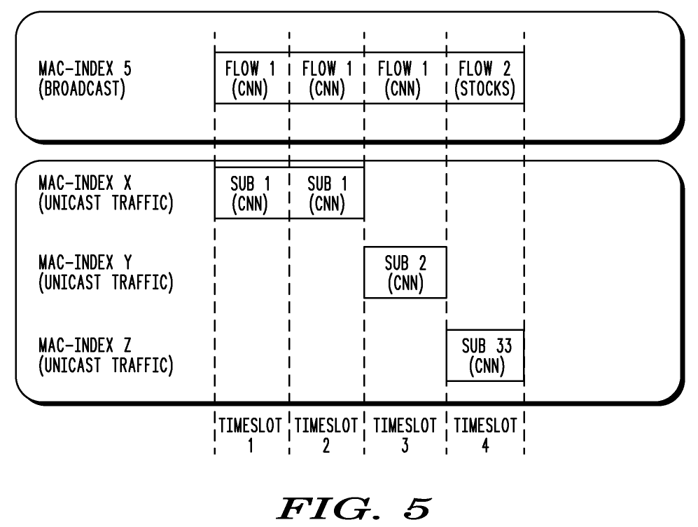

FIG. 5 is a logical flow diagram illustrating how information is wirelessly communicated to a wireless communication device using a broadcasting/multicast wireless communication mode and a wireless unicast communication mode. As described above, broadcast/multicast services deliver the same data to multiple subscribers. Communication systems such as CDMA EV-DO use maximum power to transmit data to wireless devices. The number of timeslots required, and the modulation and coding scheme are varied to deliver data to the requesting wireless communication devices 104, 106. The combination of media access control-index (“MAC-lndex”) and timeslot(s) defines a communications channel, regardless of how many wireless communication devices share the channel.

Wireless communication devices receiving information using a unicast communication mode are each assigned one MAC-index and one or more timeslots as shown in FIG. 5. Information is transmitted to a specific wireless communication device on one or more timeslots covered by the MAC-index that is assigned to the wireless communication device. Alternatively, a single MAC-index is assigned for the broadcast/multicast channel. Each timeslot may be dedicated to a single flow. Dynamically switching from many unicast channels to a single broadcast/multicast channel saves MAC-indices and reduces the number of timeslots needed, which translates to increased channel capacity. CDMA EV-DO has been used as an exemplary embodiment. However, the concepts of resource optimization are applicable to other wireless systems as well.

Exemplary Processes of Dynamically Selecting a Wireless Communication Mode Based on the Number of Time-Slots Required

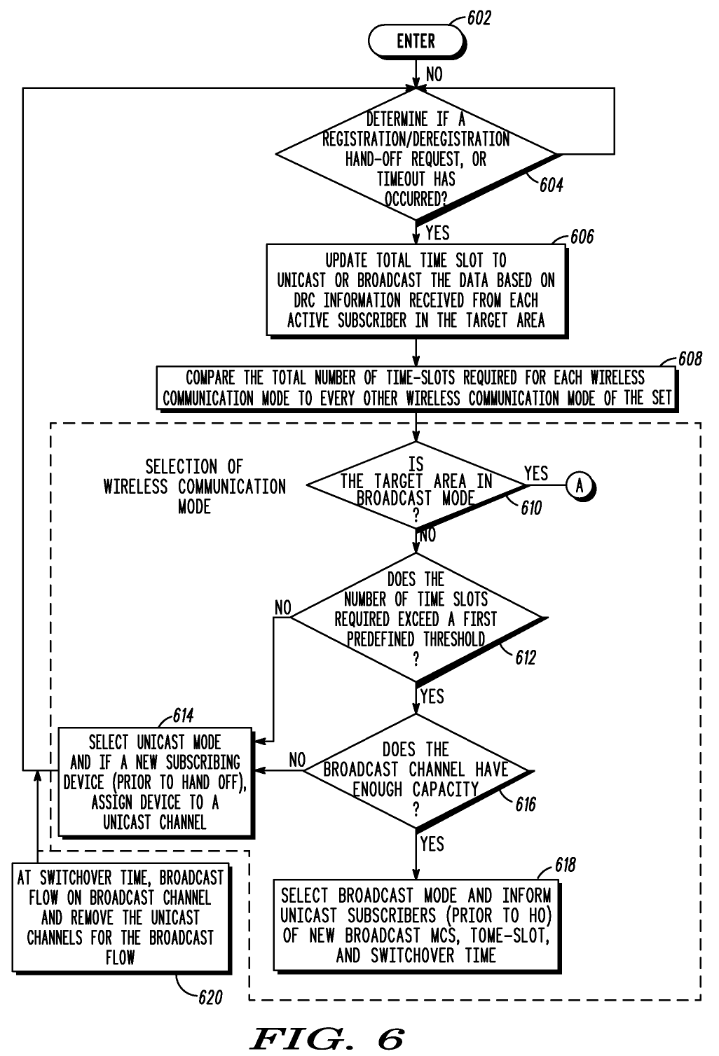

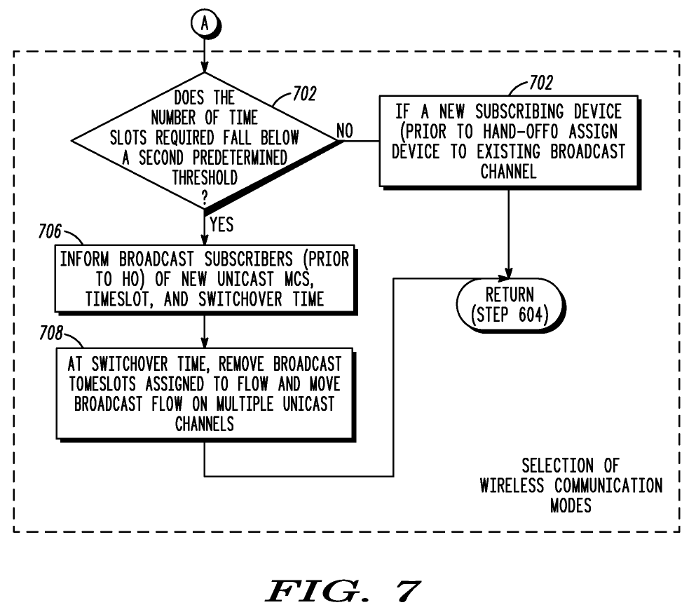

FIG. 6 and FIG. 7 are operational flow diagrams illustrating exemplary processes of dynamically selecting a wireless communication mode based on the number of required time-slots for a particular transmission of data. The operational flow diagram of FIG. 6 begins at step 602 and flows directly to step 604. The base station controller 132, at step 604, determines if a registration/deregistration, hand-off request (e.g. from a source area to a target area), timeout, or the like has occurred. If the result of this determination is negative, the base station controller 132 continues to monitor for these activities. If the result of this determination is positive, the base station controller 132, at step 606, updates the total time slot count required for broadcast and/or unicast based on the DRC information received from each active subscriber in the target area. For example, depending on where the subscriber device is located within a sector or cell, the DRC information will vary. Also, if a deregistration or handoff has occurred any unicast channels assigned to the wireless device are released.

The base station controller 132 can determine the number of time slots that are required for a unicast transmission or a broadcast/multicast transmission based on the DRC information received from each device. In one embodiment, when the BCMCS program is broadcast, the BSC 132, 430 may decide to notify all the wireless communication devices 104, 106 subscribing to the program to stop sending DRC feedback via the BCMCS overhead channel when the saving of time slots exceeds a threshold. The BSC 132, 430 can also notify these devices 104, 106 to turn on DRC feedback when the number of subscribers receiving the program goes below another threshold.

The base station controller 132, at step 608, compares the total number of time-slots required for each wireless communication mode to every other wireless communication mode of the set. The base station controller 132, at step 610, determines if the target area is in a broadcast/multicast mode. The target area can be the same sector/cell that the wireless device 104, 106 is currently in or a sector/cell that the wireless device 104, 106 is crossing over into. If the result of this determination is positive, the control flows to entry point A of FIG. 7. If the result of this determination is negative, the base station controller 132, at step 612, determines if the number of time slots required exceed a first predefined threshold. For example, the threshold can be a certain number of time slots or a range of time slots. In one embodiment, the threshold is computed at the base station controller 132 and is not pre-defined. If the result of the determination at step 612 is negative, at step 614, the unicast communication mode is selected and, if a new subscribing device, the device is assigned to a unicast channel. Next, the control flows back to step 604.

If the result of the determination at step 612 is positive, the base station controller 132, at step 616, determines if the broadcast channel has enough capacity for transmission. If the result of this determination is negative, at step 614, the unicast communication mode is selected and if a new subscribing device, the device is assigned to a unicast channel. Control then flows back to step 604. If the result of the determination at step 616 is positive, the base station controller 132, at step 618, selects the broadcast communication mode and notifies the unicast subscribers of the new broadcast modulation and coding scheme, timeslot, and switchover time. In one embodiment, a unicast subscriber is a new wireless device that has entered the cell site or is a broadcast subscribing device being handed in to the target area. If the subscribers are about to cross over into a new sector or cell, the base station controller 132 notifies the devices prior to hand-off. The base station controller 132, at step 620, broadcasts the data flow on the broadcast channel at switchover time. The unicast channels that were previously being used for broadcasting the data are removed after the switchover. The control flow then continues at step 604. It should be noted that step 610 through step 618 are part of the selection process for the wireless communication mode, as denoted by the dashed box.

Returning back to step 610, if the result of the determination is positive, the base station controller determines, at step 702, if the number of time slots required falls below a second threshold. If the result of this determination is negative, the base station controller 132, at step 704, assigns a new subscribing device to the existing broadcast channel and the control flow returns to step 604 of FIG. 6. If the result of the determination at step 702 is positive, the base station controller 132, at step 706 informs the devices subscribing to the broadcast channel of the new unicast modulation and coding scheme, time-slot, and switchover time. In one embodiment, a subscribing device can be a wireless device entering the cell site or a unicast subscribing device that is being handed in to the target area. If the devices are crossing over into a new sector/cell the base station controller 132 informs the devices of the unicast parameters prior to hand-off. When the switchover time occurs, the base station controller 132, at step 708, removes the broadcast timeslots assigned to the data flow and moves the broadcast flow to multiple unicast channels. The control flow returns to step 604 of FIG. 6. It should be noted that step 702 through step 708 are part of the selection process for the wireless communication mode as denoted by the dashed box.

NON-LIMITING EXAMPLES

The foregoing embodiments of the present invention are advantageous because they provide dynamic optimization of the resources available to wireless communication information to wireless communication devices using unicast broadcast/multicast communication modes. Information can be wirelessly communicated to a wireless communication device in a more manner thereby optimizing network resources. A further advantage is that a base station controller controls the switching between wireless communication modes. The wireless communication mode is based on the number of time-slots needed to transmit requested data. Another advantage is that the base station controller prepares wireless communication devices for a communication mode prior to a hand-off event thereby minimizing transmission gaps when crossing seams.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for dynamically selecting a wireless communication mode for wirelessly communicating information to at least one wireless communication device, the method comprising:
receiving at least one request for wireless communication of information to at least one wireless communication device;
determining a total number of time-slots required for transmitting the wireless communication of information to the least one wireless communication device for each of a set of wireless communication modes;
comparing the total number of time-slots required for each wireless communication mode to every other wireless communication mode of the set; and
selecting, based at least in part on the comparison of the total number of required time-slots, a wireless communication mode from the set of wireless communication modes for wirelessly communicating the requested information to the at least one wireless communication device.

2. The method of claim 1, further comprising:
wirelessly notifying the at least one wireless communication device to set its current wireless communication mode to the selected mode of wireless communication to receive the wireless communication of the information.

3. The method of claim 2, wherein the notifying comprises:
generating an over-the-air message including at least one of a modulation and coding scheme, selected channel information, time-slot, and switchover time associated with the selected mode of wireless communication.

4. The method of claim 1, further comprising:
notifying the at least one wireless communication device that the information type is one of point-to-point unicast, broadcast multicast using unicast, and broadcast multicast using broadcast.

5. The method of claim 1, further comprising:
notifying the at least one wireless device to one of
transmit information associated with its data rate control if the data rate control is below at least one given threshold, and
stop transmitting information associated with its data rate control if the data rate control is above at least one given threshold.

6. The method of claim 1, further comprising:
determining that the at least one wireless communication device is crossing over to a new target area; and
wirelessly transmitting a notification to the at least one wireless communication device, wherein the notification notifies the at least one wireless communication device of a wireless communication mode to transmit information to the at least one wireless communication device after it crosses over to the new target area, and wherein the wireless notification being transmitted prior to the at least one wireless communication device completely crossing over to the new target area.

7. The method of claim 6, wherein the notification further instructs the at least one wireless communication device to set its wireless communication mode to the notified wireless communication mode after the at least one wireless communication device crosses over to the new target area.

8. The method of claim 6, wherein the notification is transmitted to the at least one wireless communication device by a base station covering communication over the current target area.

9. The method of claim 1, wherein the determining of the number of time-slots required is based on at least data rate control information received from the at least one wireless communication device.

10. The method of claim 1, wherein the set of wireless communication modes includes at least one of:
a wireless information broadcast communication mode;
a wireless information multicast communication mode; and
a wireless information unicast communication mode.

11. The method of claim 1, wherein the dynamically selecting comprises selecting a wireless communication mode from the set of wireless communication modes that requires the least number of time-slots.

12. The method of claim 1, further comprising:
receiving at least one of a registration request, deregistration request, hand-off request, and a timeout associated with the wireless communication of information;
updating the total number of required time-slots for the selected wireless communication mode;
determining if the updated total number of required time-slots exceeds at least a first threshold; and
if the updated total number of required time-slots is determined to exceed the at least first threshold,
assigning the at least one wireless communication device to receive the wireless communication of the information using at least one of a wireless information broadcast communication mode and a wireless information multicast communication mode, and
transmitting a notification to the at least one wireless device to receive the wireless communication of the information using at least one of the wireless information broadcast communication mode and the wireless information multicast communication mode.

13. The method of claim 1, further comprising:
determining whether the updated total number of required time-slots is less than at least a second threshold; and
if the updated total number of required time-slots is determined to be less than the at least second threshold,
assigning the at least one wireless communication device to receive the wireless communication of the information using a wireless information unicast communication mode, and
transmitting a notification to the at least one wireless communication device to receive the wireless communication of the information using the wireless information unicast communication mode.

14. A wireless communication system for dynamically selecting a wireless communication mode for wirelessly communicating information to at least one wireless communication device, the wireless communication system comprising:
at least a base station controller, the base station controller including:
a receiver for receiving at least one request for wireless communication of information from at least one wireless communication device;
a time-slot counter for determining a total number of time-slots required for a set of wireless communication modes available for transmitting the requested wireless information;
a time-slot number comparator comparing the total number of time-slots required for each wireless communication mode to every other wireless communication mode of the set; and
a wireless communication mode selector for selecting, based at least in part on the comparison of the total number of required time-slots, a wireless communication mode from the set of wireless communication modes for wirelessly communicating the requested information to the at least one wireless communication device.

15. The wireless communication system of claim 14, further comprising:
a notifier, communicatively coupled with the wireless communication mode selector, for wirelessly transmitting a notification to the at least one wireless communication device, wherein the notification notifies the at least one wireless communication device of a wireless communication mode to transmit information to the at least one wireless communication device after it crosses over to a new target area, and wherein the wireless notification being transmitted prior to the at least one wireless communication device completely crossing over to the new target area.

16. The wireless communication system of claim 15, wherein the notification further instructs the at least one wireless communication device to set its wireless communication mode to the notified wireless communication mode after the at least one wireless communication device crosses over to the new target area.

17. The wireless communication system of claim 15, wherein the notification is transmitted to the at least one wireless communication device by a base station covering communication over the current target area.

18. The wireless communication system of claim 15, further comprising:
an over-the-air message generator communicatively coupled to the notifier for generating and wirelessly transmitting an over-the-air message including at least one of a modulation and coding scheme, selected channel information, time-slot, and switchover time associated with the selected mode of wireless communication.

19. The wireless communication system of claim 14, wherein the set of wireless communication modes includes at least one of:
a wireless information broadcast communication mode;
a wireless information multicast communication mode; and
a wireless information unicast communication mode.

20. The wireless communication system of claim 14, wherein the wireless communication mode selector selects a wireless communication mode from the set of wireless communication modes that requires the least number of time-slots.

21. The wireless communication system of claim 14, wherein the base station controller:
determines at least one of a reception of a registration request, reception of a deregistration request, reception of a hand-off request, and a timeout associated with the wireless communication of information;
updates the total number of required time-slots for the selected wireless communication mode;
determines if the updated total number of required time-slots exceeds at least a first threshold; and
if the updated total number of required time-slots is determined to exceed the at least first threshold,
assigns the at least one wireless communication device to receive the wireless communication of the information using at least one of a wireless information broadcast communication mode and a wireless information multicast communication mode, and
transmits a notification to the at least one wireless device to receive the wireless communication of the information using at least one of the wireless information broadcast communication mode and the wireless information multicast communication mode.

22. The wireless communication system of claim 14, wherein the base station controller:
determines whether the updated total number of required time-slots is less than at least a second threshold; and
if the updated total number of required time-slots is determined to be less than the at least second threshold,
assigns the at least one wireless communication device to receive the wireless communication of the information using a wireless information unicast communication mode, and
transmits a notification to the at least one wireless device to receive the wireless communication of the information using the wireless information unicast communication mode.
